(19) United States
(12) Patent Application Publication
(10) Pub. No.: US 2019/0283712 A1
(43) Pub. Date: Sep. 19, 2019

(54) VEHICLE WARMING SYSTEM

(71) Applicant: Ralph A. Sanabria, Cetral Islip, NY (US)

(72) Inventor: Ralph A. Sanabria, Cetral Islip, NY (US)

(21) Appl. No.: 15/922,209

(22) Filed: Mar. 15, 2018

(51) Int. Cl. B60S 1/02; B60H 1/00; B60S 1/66

(52) U.S. Cl. CPC B60S 1/026; B60H 1/00271; B60S 1/66; B60H 1/00657

(57) ABSTRACT

A vehicle warming system for melting snow and ice from a vehicle includes a vehicle that has a plurality of body panels, a plurality of doors and a plurality of windows. A plurality of heating units is each coupled to the vehicle. Each of the heating units is positioned within an associated one of the body panels and each of the heating units is in thermal communication with the associated body panel to melt snow and ice off of the associated body panel. A plurality of window heaters is each is positioned on an associated one of the windows of the vehicle. Each of the window heaters is in thermal communication with the associated window for melting ice and snow from the associated window. A control is coupled to the vehicle for controlling each of the heating units and each of the window heaters.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to warming devices and more particularly pertains to a new warming device for melting snow and ice from a vehicle.

### BRIEF SUMMARY OF THE INVENTION

An embodiment of the disclosure meets the needs presented above by generally comprising a vehicle that has a plurality of body panels, a plurality of doors and a plurality of windows. A plurality of heating units is each coupled to the vehicle. Each of the heating units is positioned within an associated one of the body panels and each of the heating units is in thermal communication with the associated body panel to melt snow and ice off of the associated body panel. A plurality of window heaters is each is positioned on an associated one of the windows of the vehicle. Each of the window heaters is in thermal communication with the associated window for melting ice and snow from the associated window. A control is coupled to the vehicle for controlling each of the heating units and each of the window heaters.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a left side phantom view of a vehicle warming system according to an embodiment of the disclosure.

FIG. 2 is a top phantom view of an embodiment of the disclosure.

FIG. 3 is an interior view of a door of a vehicle of an embodiment of the disclosure.

FIG. 4 is a front phantom view of an embodiment of the disclosure.

FIG. 5 is a back phantom view of an embodiment of the disclosure.

FIG. 6 is a cross sectional view taken along line 6-6 of FIG. 2 of an embodiment of the disclosure.

FIG. 7 is a right side view of an embodiment of the disclosure.

FIG. 8 is a back phantom view taken along line 8-8 of FIG. 3 of an embodiment of the disclosure.

FIG. 9 is a cross sectional view taken along line 9-9 of FIG. 3 of an embodiment of the disclosure.

FIG. 10 is a schematic view of an embodiment of the disclosure.

### DETAILED DESCRIPTION OF THE INVENTION

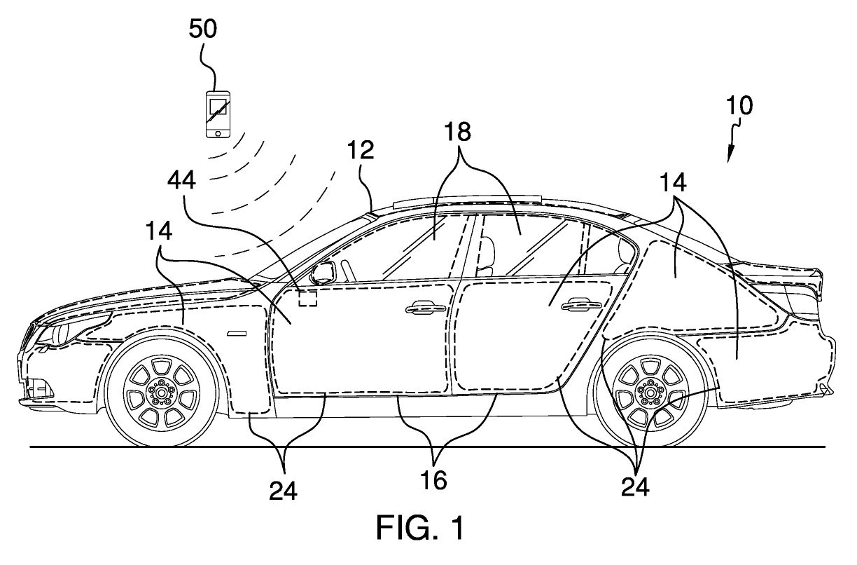

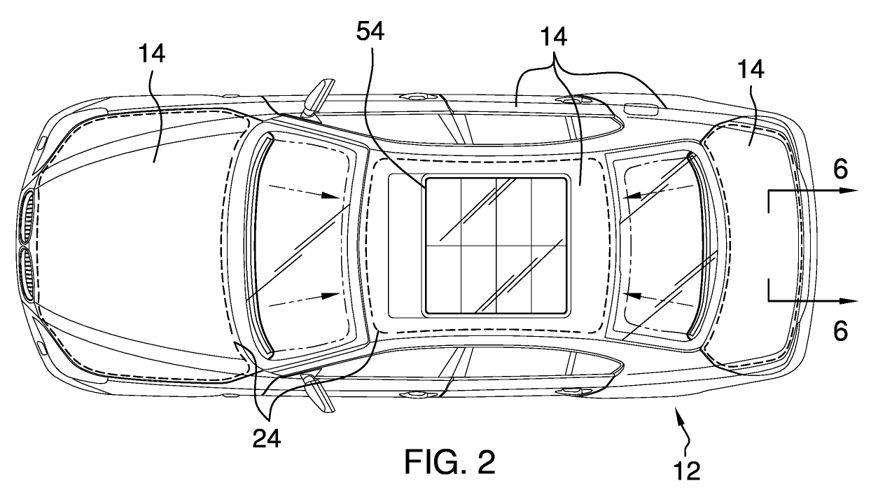

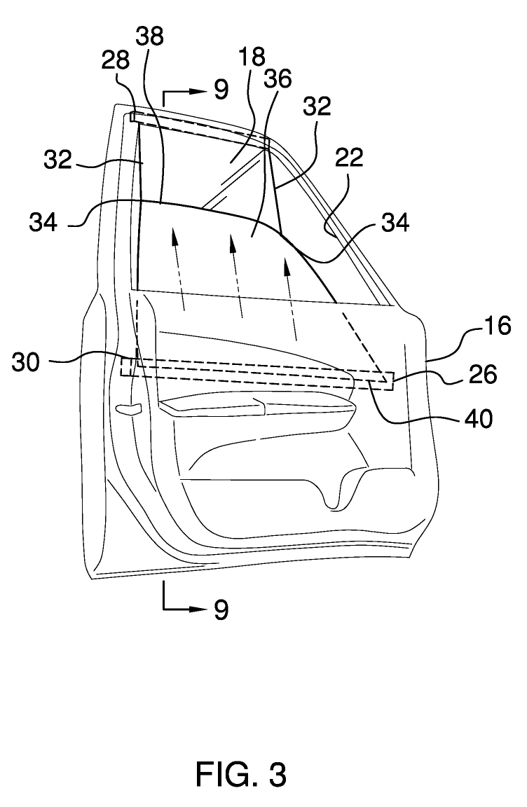

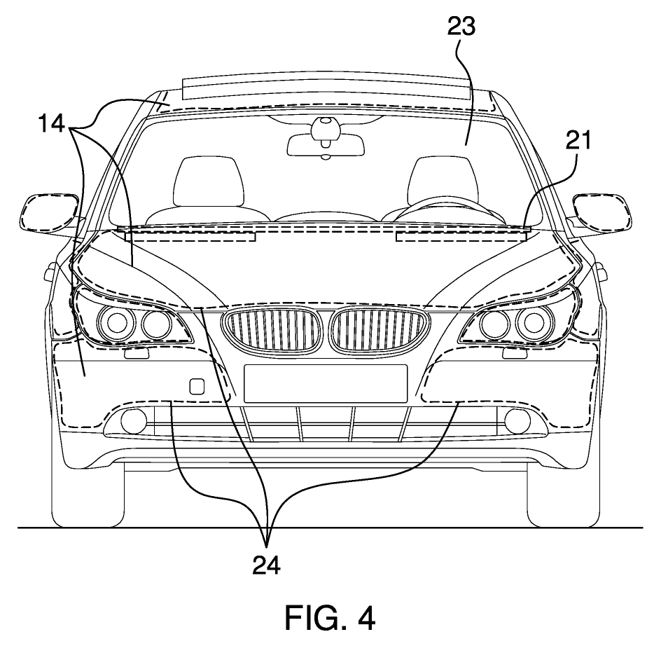

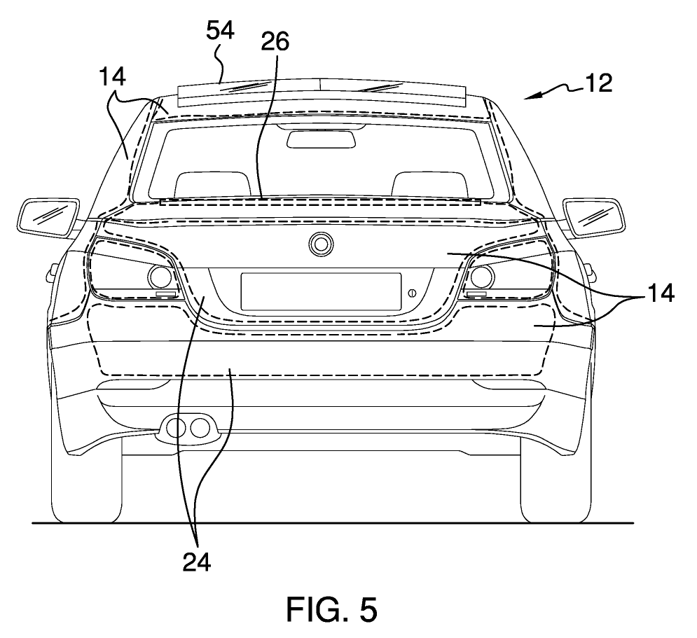

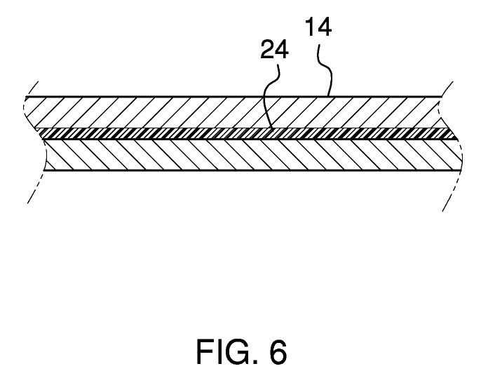

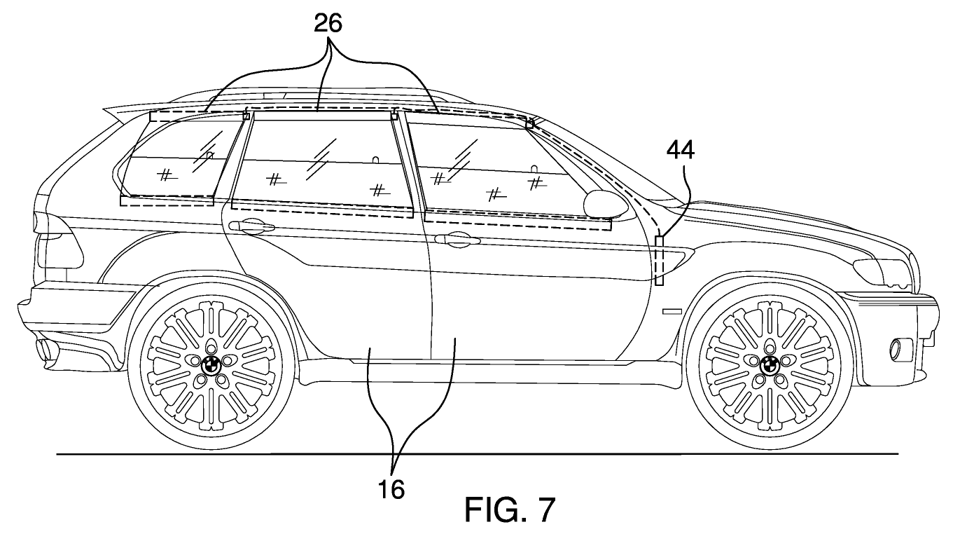

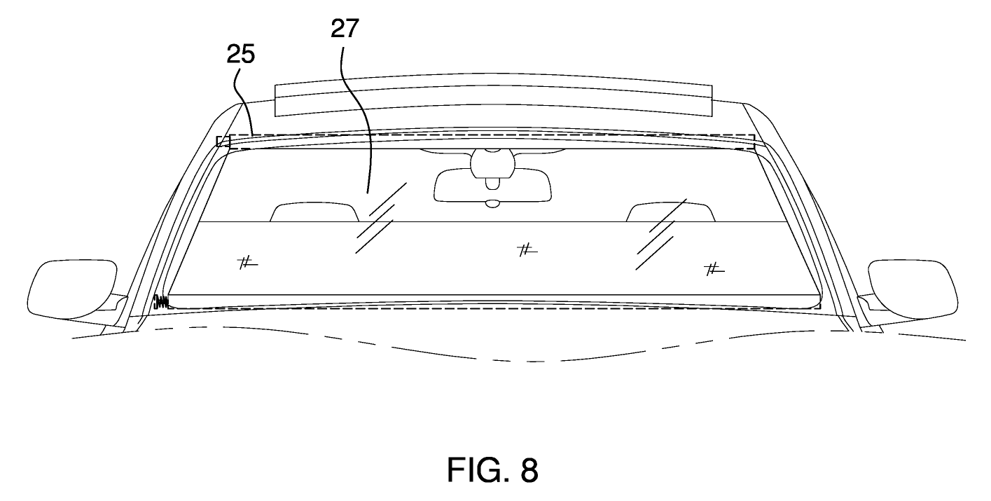

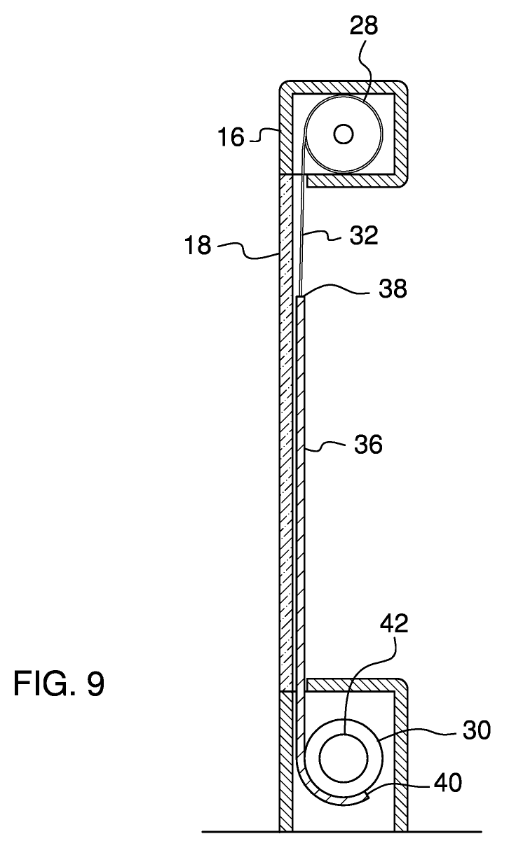

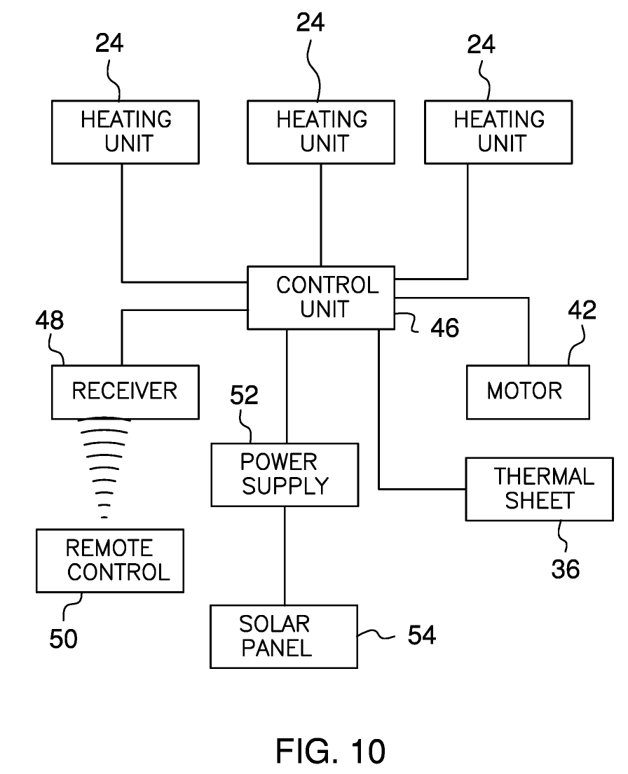

With reference now to the drawings, and in particular to FIGS. 1 through 10 thereof, a new warming device embodying the principles and concepts of an embodiment of the disclosure and generally designated by the reference numeral 10 will be described.

As best illustrated in FIGS. 1 through 10, the vehicle warming system 10 generally comprises a vehicle 12 that has a plurality of body panels 14, a plurality of doors 16 and a plurality of windows 18. The body panels 14 may include bumpers, exterior mirrors, doors, a hood, a trunk, fenders and any other body panel that is conventional to enclosed, motorized vehicles. Each of the doors 16 has a window opening 22. Additionally, the vehicle 12 may be a passenger vehicle 12, a cargo vehicle 12 and any other vehicle 12 that has exterior body panels comprised of a thermally conductive material.

A plurality of heating units 24 is provided and each of the heating units 24 is coupled to the vehicle 12. Moreover, each of the heating units 24 is positioned within an associated one of the body panels 14 and each of the heating units 24 is in thermal communication with the associated body panel 14. Each of the heating units 24 is actuated to warm the associated body panel to melt snow and ice off of the associated body panel. Each of the heating units 24 may comprise electrical heating elements, an electronic thermal panel and any other type of electronic heating device.

A plurality of window heaters 26 is provided and each of the window heaters 26 is positioned on an associated one of the windows 18 of the vehicle 12. Moreover, each of the window heaters 26 is in thermal communication with the associated window 18. Each of the window heaters 26 is actuated to warm the associated window 18 for melting ice and snow from the associated window 18. Additionally, each of the window heaters 26 is selectively deployed and retracted.

Each of the window heaters 26 comprises a first roller 28 that is rotatably positioned inside an associated one of the doors 16. The first roller 28 is positioned above the window opening 22 in the associated door 16. Additionally, the first roller 28 is biased to rotate in a first direction and the first roller 28 is rotatable in a second direction. A second roller 30 is rotatably inside of the associated door 16 with respect to the first roller 28. The second roller 30 is positioned below the window opening 22 in the associated door 16 with respect to the first roller 28; the second roller 30 is rotatable in a deploying direction and a retracting direction.

Each of the window heaters 26 includes a plurality of cables 32. Each of the cables 32 is attached to the first roller 28 and extends downwardly therefrom and each of the cables 32 is wound onto the first roller 28 when the first roller 28 rotates in the first direction. Moreover, the first roller 28 rotates in the second direction when each of the cables 32 is pulled outwardly from the first roller 28. Each of the cables 32 has a distal end 34 with respect to the first roller 28.

Each of the window heaters 26 includes a thermal sheet 36 that has a top edge 38 and a bottom edge 40. The distal end 34 corresponding to each of the cables 32 is coupled to the top edge 38 of the thermal sheet 36 and the bottom edge 40 is coupled to the second roller 30. The thermal sheet 36 is urged upwardly to cover the window opening 22 in the associated door 16 when the first roller 28 rotates in the first direction. Thus, the thermal sheet 36 is placed in thermal communication with the window that is positioned in the associated door 16. The thermal sheet 36 may comprise an electronic thermal blanket or the like that is comprised of a transparent material.

Each of the window heaters 26 includes a motor 42 that is coupled to the associated door 16 with respect to the first roller 28 and the second roller 30. The motor 42 is rotatably coupled to the second roller 30 and the motor 42 rotates the second roller 30 in the deploying direction or the storing direction. The thermal sheet 36 is wound around the second roller 30 when the motor 42 rotates the second roller 30 in the storing position. Additionally, the first roller 28 rotates in the first direction when the motor 42 rotates the second roller 30 in the deploying direction. In this way the cables 32 urge the thermal sheet 36 upwardly to cover the window opening 22 wherein the thermal sheet 36 is placed in thermal communication with the associated window 18. The motor 42 may be an electric motor or the like. The plurality of window heaters 26 includes a windshield heater 21 that is aligned with a windshield 23 in the vehicle 12 and a rear window heater 25 that is aligned with a rear window 27 of the vehicle 12.

A control 44 is coupled to the vehicle 12 and the control 44 is in electrical communication with each of the heating units 24 and each of the window heaters 26. The control 44 is actuated to turn on each of the heating units 24 and to turn on each of the window heaters 26. The control 44 comprises a control circuit 46 that is coupled to the vehicle 12. The control circuit 46 may be integrated into existing circuitry in the vehicle 12 and the control 44 may include buttons that are incorporated into the dashboard of the vehicle 12.

The control 44 includes a receiver 48 that is coupled to the vehicle 12 and the receiver 48 is electrically coupled to the control circuit 46. The receiver 48 is in wireless electrical communication with a remote control 50, such as a smart phone or the like, for remotely controlling each of the heating units 24 and each of the window heaters 26. Additionally, the receiver 48 may be a radio frequency receiver or the like and the receiver 48 may employ a WPAN signal and Bluetooth communication protocols. The control 44 may receive a manually generated turn on signal from the remote control 50. Additionally, remote control 50 may have weather forecast software stored therein, and the weather forecast software may automatically turn the control 44 on when inclement weather is forecast for the immediate future.

A power supply 52 is electrically coupled to the control circuit 46 and the power supply 52 comprises the electrical system of the vehicle 12. Additionally, the power supply 52 includes a solar panel 54 that is positioned on a roof of the vehicle 12. The solar panel 54 is electrically coupled to the electrical system of the vehicle 12 to charge the vehicle's battery when the heating units 24 and the window heaters 26 are turned on.

In use, the remote control 50 is manipulated to turn on the heating units 24 and to deploy each of the window heaters 26 when freezing precipitation, such as snow or ice, has begun or is expected. The heating units 24 heat the body panels 14 and the window units heat the windows 18. In this way the vehicle 12 and the windows 18 are kept free of snow and ice thereby facilitating the vehicle 12 to be driven at a moment's notice in freezing precipitation. Additionally, the heating units 24 and the window heaters 26 can each be turned on when freezing precipitation has previously collected on the vehicle 12. In this way the freezing precipitation that has collected on the vehicle 12 can be melted away prior to driving the vehicle 12. Each of the window heaters 26 is turned off when the vehicle 12 is being driven thereby facilitating access through the windows 18 when the windows 18 are rolled down.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle warming system configured to melt snow and ice off of a vehicle, said snow and ice melting system comprising:
a vehicle having a plurality of body panels, a plurality of doors and a plurality of windows;
a plurality of heating units, each of said heating units being coupled to said vehicle, each of said heating units being positioned within an associated one of said body panels, each of said heating units being in thermal communication with said associated body panel, each of said heating units being actuated to warm said associated body panel wherein each of said heating units is configured to melt snow and ice off of said associated body panel;
a plurality of window heaters, each of said window heaters being positioned on an associated one of said windows of said vehicle, each of said window heaters being in thermal communication with said associated window, each of said window heaters being actuated to warm said associated window for melting ice and snow from said associated window, each of said window heaters being selectively deployed and retracted; and
a control being coupled to said vehicle, said control being in electrical communication with each of said heating units and each of said window heaters, said control being actuated to turn on each of said heating units and each of said window heaters.

2. The assembly according to claim 1, wherein:
each of said doors has an inside surface and a window opening; and
each of said window heaters comprises a first roller being rotatably positioned inside an associated one of said doors, said first roller being positioned above said window opening in said associated door, said first roller being biased to rotate in a first direction, said first roller being rotatable in a second direction.

3. The assembly according to claim 2, further comprising a second roller being rotatably positioned inside said associated door with respect to said first roller, said second roller being positioned below said window opening in said associated door with respect to said first roller, said second roller being rotatable in a deploying direction and a retracting direction.

4. The assembly according to claim 3, further comprising a plurality of cables, each of said cables being attached to said first roller and extending downwardly therefrom, each of said cables being wound onto said first roller when said first roller rotates in said first direction, said first roller rotating in said second direction when each of said cables are pulled outwardly from said first roller, each of said cables having a distal end with respect to said first roller.

5. The assembly according to claim 4, further comprising a thermal sheet having a top edge and a bottom edge, said distal end corresponding to each of said cables being coupled to said top edge of said thermal sheet, said bottom edge being coupled to said second roller, said thermal sheet being urged upwardly to cover said window opening in said associated door when said first roller rotates in said first direction such that said thermal sheet is in thermal communication with an associated one of said windows being positioned in said associated door.

6. The assembly according to claim 5, further comprising a motor being coupled to said associated door with respect to said first roller and said second roller, said motor being rotatably coupled to said second roller, said motor rotating said second roller in said deploying direction or said storing direction.

7. The assembly according to claim 6, wherein said thermal sheet is wound around said second roller when said motor rotates said second roller in said storing position.

8. The assembly according to claim 6, wherein said first roller rotates in said first direction when said motor rotates said second roller in said deploying direction such that said cables urge said thermal sheet upwardly to cover said window opening wherein said thermal sheet is placed in thermal communication with said associated window.

9. The assembly according to claim 1, wherein:
each of said window units includes a thermal sheet and a motor; and
said control comprises a control circuit being coupled to said vehicle, said control circuit being electrically coupled to each of said heating units, said thermal sheet corresponding to each of said window heaters and said motor corresponding to each of said window heaters.

10. The assembly according to claim 9, further comprising a receiver being coupled to said vehicle, said receiver being electrically coupled to said control circuit, said receiver being configured to be in wireless electrical communication with a remote control for remotely controlling each of said heating units and each of said window heaters.

11. The assembly according to claim 10, further comprising a power supply being electrically coupled to said control circuit, said power supply comprising an electrical system of said vehicle.

12. A vehicle warming system configured to melt snow and ice off of a vehicle, said snow and ice melting system comprising:
a vehicle having a plurality of body panels, a plurality of doors and a plurality of windows, each of said doors having an inside surface and a window opening;
a plurality of heating units, each of said heating units being coupled to said vehicle, each of said heating units being positioned within an associated one of said body panels, each of said heating units being in thermal communication with said associated body panel, each of said heating units being actuated to warm said associated body panel wherein each of said heating units is configured to melt snow and ice off of said associated body panel;
a plurality of window heaters, each of said window heaters being positioned on an associated one of said windows of said vehicle, each of said window heaters being in thermal communication with said associated window, each of said window heaters being actuated to warm said associated window for melting ice and snow from said associated window, each of said window heaters being selectively deployed and retracted, each of said window heaters comprising:
a first roller being rotatably positioned inside an associated one of said doors, said first roller being positioned above said window opening in said associated door, said first roller being biased to rotate in a first direction, said first roller being rotatable in a second direction;
a second roller being rotatably positioned inside said associated door with respect to said first roller, said second roller being positioned below said window opening in said associated door with respect to said first roller, said second roller being rotatable in a deploying direction and a retracting direction;
a plurality of cables, each of said cables being attached to said first roller and extending downwardly therefrom, each of said cables being wound onto said first roller when said first roller rotates in said first direction, said first roller rotating in said second direction when each of said cables are pulled outwardly from said first roller, each of said cables having a distal end with respect to said first roller;
a thermal sheet having a top edge and a bottom edge, said distal end corresponding to each of said cables being coupled to said top edge of said thermal sheet, said bottom edge being coupled to said second roller, said thermal sheet being urged upwardly to cover said window opening in said associated door when said first roller rotates in said first direction such that said thermal sheet is in thermal communication with an associated one of said windows being positioned in said associated door;
a motor being coupled to said associated door with respect to said first roller and said second roller, said motor being rotatably coupled to said second roller, said motor rotating said second roller in said deploying direction or said storing direction, said thermal sheet being wound around said second roller when said motor rotates said second roller in said storing position, said first roller rotating in said first direction when said motor rotates said second roller in said deploying direction such that said cables urge said thermal sheet upwardly to cover said window opening wherein said thermal sheet is placed in thermal communication with said associated window; and
a control being coupled to said vehicle, said control being in electrical communication with each of said heating units and each of said window heaters, said control being actuated to turn on each of said heating units and each of said window heaters, said control comprising:
a control circuit being coupled to said vehicle;
a receiver being coupled to said vehicle, said receiver being electrically coupled to said control circuit, said receiver being configured to be in wireless electrical communication with a remote control for remotely controlling each of said heating units and each of said window heaters; and
a power supply being electrically coupled to said control circuit, said power supply comprising an electrical system of said vehicle.
